(19) United States
(12) Patent Application Publication
(10) Pub. No.: US 2012/0331177 A1
(43) Pub. Date: Dec. 27, 2012

(54) METHOD AND SYSTEM TO SYNCHRONIZE DATA SETS FOR PERSONAL DEVICES

(75) Inventor: Søren Borup Jensen, Struer (DK)

(73) Assignee: Bang & Olufsen A/S, Struer (DK)

(21) Appl. No.: 13/483,772

(22) Filed: May 30, 2012

(30) Foreign Application Priority Data
Jun. 21, 2011 (DK) DK PA 2011 00468

(51) Int. Cl. G06F 15/16

(52) U.S. Cl. 709/248

(57) ABSTRACT

The present invention relates to a method of synchronizing data to be shared among two or more devices, the data sharing may be performed via a networked server utility. The method applied enhances the usability of media players and providing media information to one or more user(s). The media player may be a portable device, and the server utility is considered to be a “virtual cloud” device.

### FIELD OF INVENTION

The present invention relates to a method of synchronizing data to be shared among two or more devices, the data sharing preferably to be performed via a networked server utility. The method applied enhances the usability of media players and providing media information to one or more users. The portable device may be a media player.

### BACKGROUND OF THE INVENTION

More and more small mobile devices are present at the market.

Mobile devices like mobile phones, smart phones, media players, tablets, and book readers with specific product examples like the iPod, iPad, iPodTouch, and iPhone are characterized as being small and very effective type of products, when talking about digital data handling and providing media information to users. Typically the mobile device has storage means, data communication means, Internet access, and control means as well as provider means for audio and video.

This type of equipment is normally considered to be a personal device, thus every person has his/her own data sources and upload/download of data from/to external sources are specific for each person. An example of an external data source is the music provider/store iTunes.

This gives the problem of keeping data consistent for the user in the situations where:
The user has more than one portable device, raising the question whether all devices must have the same data set, thus synchronized to have the same collection of: music files, emails, AV files, movie files, photo files etc.
More users each having personal devices and possibly sharing some of the devices with other users. Every user has a mobile phone and e.g. two persons in the household share a tablet PC, this e.g. being an iPad.

Prior art products and systems exist in which synchronization of mobile devices owned and used by a single person is managed.

A prior art document US 2011078332 discloses a method which allows synchronizing data across multiple computing devices communicating wirelessly.

The present invention differs from the referred prior art in that the method comprises synchronization of two or more portable devices of which at least one may be used by two or more people, and by downloading/storing different data depending of the user and optionally with a specified synchronize option specific directed against one or more users.

It is an object of the invention to disclose a method and a system to synchronize one or more portable devices, of which at least one may be used by two or more people, with data from a common data source.

Specifically, the invention discloses a method where the data source and storage may be a virtual device on the Internet also named the “cloud”.

Supplemental to or as an alternative to connecting to a portable device the docking station may connect to a multimedia server—stationary or portable as appropriate.

A first aspect of the invention relates to a method of synchronizing a first and a second device, the method comprising:
a) receiving or generating a media file in or at the first device,
b) receiving, after step a), an indication of a user identity of a user and storing the media file in the first device in accordance with the indicated user identity,
c) synchronizing the stored media file to the second device,
   wherein the synchronizing step comprises:
transmitting the media file and first information relating to the user identity to a synchronizing unit,
the second device holding second information relating to the identity/ies of one or more users to the synchronizing unit,
the second device receiving the media file from the synchronizing unit, and storing the media file, if the user identity of the first information matches a user identity of the second information.

In the present context, a synchronization may be any type of transfer of data from one of the first and second devices to the other, either directly or via one or more third elements, such as servers or the like. The transfer or synchronization may take place via any type of data connection, such as a cabled connection or a wireless connection, or a combination thereof. Such connections typically comprise one or more routers, switches or the like, as is known in the art. The synchronization may be performed via one or more other devices, such as one or more servers or the like, available locally, such as on an intranet, or remotely, such as via the WWW.

Naturally, the synchronization may be a file/data transfer in both directions between the first and second devices.

A synchronization may be an operation in which certain types of data or data in predetermined areas of storages or predetermined user profiles or the like are brought into conformance between the first and second devices, so that if data is provided, received or updated in one of the first and second devices, such data is transferred to the other device to also have that device updated and in conformance with the first device.

Synchronization may be performed between certain types of data, such as media libraries holding files for audio, video, images or the like, and which are desired on both of the first and second devices. Thus, if a file exists on the first device but not on the second device, the synchronization may correct this and copy the file also to the second device.

In this context, the file may be received, such as from an external source, such as a camera, a microphone or a communication input, such as an internet connection used for downloading media files from external sources/servers.

Alternatively, the file may be generated by the device, such as if the device has a camera or a microphone. A file may also be generated from other files by cutting and pasting in one or more other media files to generate a new media file. In this situation, the device preferably has a monitor and/or speakers for providing the media files to a user and allowing the user to edit these to generate the new media file.

Having thus received or generated the media file, the user is requested to indicate his/her identity. This indication may be entered in a number of manners, such as using a keyboard for entering the identity (name, password, user name, other text, or the like), or the user may indicate his/her identity by pointing to an area on a monitor at which the identity of the user is given, such as in the situation where multiple identities exist, each of which is indicated in different areas on the monitor. Naturally, the indication may alternatively be entered via a microphone, if the user speaks, so that the user's voice may be recognized, or words are recognized and compared to user identities. Other types of user recognition comprise iris detection, face recognition, fingerprint recognition or other biometric methods.

A further manner of indicating an identity is the touching a touch pad in a predetermined pattern, as is seen in mobile phones, or the detection of a predetermined movement of the device or an element thereof, where different users use different movements (shaking, tapping on the device, rotation, translation, or the like), if the element or device has one or more movement sensors, such as accelerometers.

Knowing the identity of the user, the media file may now be stored in the first device. This storage is in accordance with the user identity. This accordance may be the storing of the media file in a storage location, such as a media library, folder, database or the like, reserved for the indicated user. Alternatively, the file may be stored in a storage not necessarily reserved for the user but tagged or marked, such as by introducing the identity or information from which the identity may be derived, into the media file or storing such information in a manner so that it may be related to the file. Thus, the “accordance” relates to the fact that the media file(s) may be determined from the user identity and/or the user identity(ies) may be determined from a media file.

Naturally, a media file may be associated to multiple users, such as in the situation where a user allows other users to experience the media file, or when different users download the same file. Alternatively, duplicates may be allowed in the storage to keep the media files of different users fully separated.

It is noted that the user identity is not entered or indicated until the media file has been received or generated. This has the advantage that the actual device may be used by multiple users, such as without having to log on as a particular user and log off to have another user log on, as would be the usual situation in the PC universe. In the iPad and mobile telephone universe, these elements are initially thought of as single-user devices, whereby they do not directly support different users. However, when requesting a user identity subsequent to receipt/generation of a media file, even using such devices, the users may have their own media libraries and may have such libraries synchronized to other devices which the user uses, without having such libraries “polluted” with the media files of the other users.

Having now received/generated and stored the media file, the device is in need of synchronization, as the second device also should have this file, if it is used by the same user.

Thus, the synchronization step is performed. This step may be performed when requested by a user of any of the first and second devices or periodically, such as if controlled by a timer in one of the devices or a synchronization server with which at least one of the devices communicates. Alternatively, the synchronization may be performed when data, which are to be synchronized, are stored or updated in one of the devices.

During the synchronization step, the media file is transmitted to the second device, if the second device has, as a user, the user indicated at receipt or generation of the media file. Both the first and the second devices preferably has a list of user identities of users having access to the device. In the situation where the first or second device are single user devices, such as a mobile telephone, only a single user identity is required.

Preferably, the synchronization takes place via a synchronization server or unit to which the media file is transmitted together with first information from which the user identity indicated may be determined. This first information may be any type of information from which a user may be determined, such as a number, a user name, an account number, or the like.

The second device than receives and stores the media file, if the first information matches the second information in which the second device holds identities of users having access to, or having had access to, the second device.

The second information may relate to a single user or multiple, individual users. Alternatively or in addition, the second information may relate to one or more groups of users, where it is possible to determine, whether a given person is a member of a group or not.

In one embodiment, the synchronization step comprises the second device transmitting to the synchronizing unit the second information and the synchronizing unit transmitting the media file to the second unit, if the user identity of the first information matches a user identity of the second information. Alternatively, the second information may be transmitted to the first device, such as in the situation where no synchronizing unit is present.

In this situation, the synchronizing unit, or the first device, performs the determination of whether to forward the media file to the second unit. The second unit thus, and a link between the synchronizing unit and the second device, only receives media files which are destined for the second device.

In another embodiment, the synchronization step comprises the synchronizing unit transmitting the media file and the first information to the second unit, and the second unit storing the media file if the user identity of the first information matches a user identity of the second information. Alternatively, the first device may forward the media file and the first information directly to the second device.

In this situation, the second device may determine whether the media file is for a user of the second device or not. If so, the file is stored. If not, the file may be discarded.

In a preferred embodiment, the step of the second device storing the media file comprises the second device storing the media file in accordance with the indicated identity. The second device preferably also has storage areas or has other manners of indicating that a media file is for use by a specific user. One other manner may be to add to or with the media file information relating to which user(s) is/are allowed access to the media file.

One embodiment further comprises the step of, subsequent to step b), receiving a second indication of a user identity and providing access to (only) media files stored in accordance with the identity of the second indication. This step may be performed in any of the first and second devices and relates to the situation where a user of a device wishes to access the files of his/her library or storage area. In this situation, the user will enter an indication, described above, of his/her identity, where after the device will allow access to the media files stored in accordance with the user's identity. Again, this step may be performed while operating the device so that it is not performed during a log-in procedure. Any user may use the device, before one of the users indicates his/her identity, where after access is granted to that user's media files.

Naturally, a log-out may be performed in order to no longer have these files accessible, so that either another user's files may become accessible, if it is desired that only a single user's files are accessible at the time, or so as to allow other users to use the device without having access to the files.

Another aspect of the invention relates to a system comprising a first and a second device as well as a synchronizing unit, wherein:
the first device comprises:
   a media file receiving part and/or a media file generating element,
   an input element operable to receive an indication of a user identity of a user,
   a first storage,
   a first processor operable to operate the input element subsequent to the media file receiving part and/or the media file generating element and to store a received or generated media file in the first storage in accordance with the indicated user identity, and
   an output element operable to output a stored media file and first information relating to the pertaining indicated user identity,
the synchronizing unit comprises:
   a first receiver for receiving the stored media file and the first information,
   a second receiver for receiving second information relating to the identity/ies of one or more users,
   an output for outputting the media file and the first information to the second device,
   and a processor operable to compare the first and second information and instruct the output to output the media file when the first information matches the second information,
the second device comprises:
   a second receiver for receiving the media file,
   a second output for outputting the second information,
   a second storage and
   a second processor operable to store the media file in the second storage.

In this context, the first and second devices may be any type of device able to receive, send, store, generate or provide files, such as media files. A device may be a mobile telephone, a smart phone, a PC, a computer, a server, a laptop, a tablet PC, an iPad, a reader, an iPhone, a TV, a media player, an iPod, or the like. Usually, a device will be able to provide media files to a user and thus has one or more speakers and a display as well as means for entering information, such as a keyboard, a touch pad, touch display or the like.

As described in relation to the first aspect, the first and second devices may forward the media file and optionally the first or second information directly to each other, but preferably a synchronizing unit is provided “between” these devices.

The devices also preferably comprise elements for communicating with each other and/or other elements, such as the synchronizing unit and/or other computers/servers available in the vicinity, such as via a LAN, or remotely, such as via the WWW. Such communicating elements may be MACs, NICs, elements for performing wired or wireless communication using any desired protocol, such as the Ethernet protocol. Naturally, when communicating with the synchronizing unit or the other device, the communication may be performed via other network components such as switches or routers.

The first device comprises a media file receiving part and/or a media file generating element. As mentioned above, this device may be a camera/microphone for generating media information or an element (usually a user interface) allowing the user to alter existing media files to generate a new media file. Alternatively, the file may be received using the above-mentioned standard networking equipment, using which the file may be received from another computer, a camera or the like, such as downloaded from a remote server, such as via the WWW.

The first device has an input element operable to receive an indication of a user identity of a user. This input element may form part of any user interface and thus may be a keyboard, touch pad, touch display, fingerprint reader, iris reader, movement sensor(s), biometric sensor(s) or the like.

The storage may be based on any type of storage technology, such as RAM, ROM, PROM, EPROM, EEPROM, Flash, solid state memory, DVD, CDROM, Blueray disc, optical disc, hard drives, hard discs, or the like. Usually, the storage may be present in the actual first device so that the file is available even when the device has no network covering connecting it to a remote server or the like.

The first processor may be based on any technology, such as a hardwired or software programmable processor, an ASIC, an FPGA or any combination thereof. The processor is operable to operate the input element so as to e.g. receive the indication or data representing the indication in order to be able to determine the identity of the user.

The processor is operable to receive or accept the indication subsequent to its operation of the media file receiving part and/or the media file generating element. Thus, the processor ensures that the file is received or generated, before the processor accepts the indication.

Finally, the processor is operable to store a received or generated media file in the first storage in accordance with the indicated user identity. This “accordance” is described further above.

The first device also has an output element operable to output a stored media file and first information relating to the pertaining indicated user identity.

The synchronization unit may be optional. In that case, the information forwarded from the first and second devices is transmitted directly to the other device.

The synchronizing unit may be a computer/server or the like, which is available on a network either locally or remotely. This unit comprises a first receiver for receiving the stored media file and the first information and a second receiver for receiving second information relating to the identity/ies of one or more users, as well as an output for outputting the media file and the first information to the second device. These receivers/output may be standard networking interfaces adapted to communicate with the devices and computers in general using any desired standard, such as the Ethernet standard.

The synchronizing unit also has a processor, which may be of the above types, which is operable to compare the first and second information and instruct the output to output the media file when the first information matches the second information. Thus, the media file is only output, when the match is found. This is described above, where the first and second information may represent a single user, a number of individual users and/or one or more groups of users. The match usually will be an overlap of at least one user in the first and second information.

The second receiver and the second output of the second device may also be standard communication devices.

It is noted that the second receiver may also receive the first information if desired. This first information may be used by the second device to ensure storage of the media file in the correct manner. This is described further below.

The second device also comprises a second storage which may be of the same type or another type than the above first storage.

The second processor may be of the same or another type than the first processor. This processor may be connected to the second receiver/output, as the first processor may be connected to the first receiver/generator and output, and is operable to store the media file in the second storage.

A final aspect of the invention relates to a system comprising a first and a second device as well as a synchronizing unit, wherein:
the first device comprises:
   a media file receiving part and/or a media file generating element,
   an input element operable to receive an indication of a user identity of a user,
   a first storage,
   a first processor operable to operate the input element subsequent to the media file receiving part and/or the media file generating element and to store a received or generated media file in the first storage in accordance with the indicated user identity, and
   an output element operable to output a stored media file and first information relating to the pertaining user identity,
the synchronizing unit comprises a first receiver for receiving the media file and the first information and an output for outputting the media file and the first information,
the second device comprises:
   a second receiver for receiving the media file and the first information,
   a second storage and
   a second processor operable to compare the first information to second information relating to the identity/ies of one or more users of the second device and to, if the first information matches the second information, store the media file in the second storage.

The main difference between the final and the former aspect is that the output of the synchronizing unit is operable to output both the media file and the first information, and that the second processor is operable to compare the first information to second information relating to the identity/ies of one or more users of the second device and to, if the first information matches the second information, store the media file in the second storage.

Thus, the media file and first information is transmitted to the second device where the decision to store is made. If no match is found, the media file and the first information may be discarded.

In one situation, the second processor is operable to store the media file in accordance with the first information. As mentioned above, this “accordance” may be storage in a storage area (e.g. library or folder structure) reserved for the user or a group of users comprising the user. Alternatively, the media file may be stored with, such as including, information describing the identity of the user. Generally, it is desired that the identity of the user—or group of users—may be determined from the media file or a location in which it is stored.

In one embodiment, the first input element is further operable to receive a subsequent, second indication of a user identity, where the processor is operable to receive the second indication and provide access to media files stored in accordance with the identity of the second indication, preferably, the access is only to media files stored in accordance with the identity.

This restriction from access to other files may be handled in a number of manners. In one situation, other files may simply be invisible to the user. In other situations, the files are encrypted with different keys, where a user only has access to a single key and is thereby not able to decrypt the other media files. A number of operating systems provide different manners of reserving spaces or files for certain users and preventing other users from gaining access to such files.

The following embodiments may be combined with the above aspects in any manner.

A first embodiment is a method to synchronize one or more portable devices, frequently used by two or more people, with data from common data storage, where the data storage includes user file folders, the synchronization characterized by:
An action triggered by a first user operation performed on first device generates a first data record in the first device, the data record partly or fully being the output from an application program running in the first device or the data record partly or fully being data downloaded from a service provider on a networked server (cloud);
Upon a first synchronization event, the first data record is uploaded from the first device to the server (cloud) and appended to the server data sets that include user data from one or more users;
Upon a second synchronization event, the first data record is downloaded from the server (cloud) and appended to the data sets residing on each of the addressed devices;
The addressed devices are according to specified synchronization options, the options being to synchronize all devices, or synchronize all devices for specific one or more user(s), or synchronize specific devices for specific one or more user(s).

In a second embodiment, the first synchronization event and second synchronization event are being triggered in one of different options:
It executes automatically per time unit, e.g. in relation with another system application running in the device.
It executes per user request, i.e. the user specifically commands a synchronization to take place.
It executes per server (cloud) request like a system function running in the server, e.g. a back up application or alike.

The update that is part of the synchronization of the data sets in each of the devices may be based on standard procedures, in which files from a folder is downloaded to the device(s).

This mode of download may be a delta update, where only new data are appended, or it may be a fully update of all data in folder; this mode being according to available features in the operating system in a give device.

In a third embodiment the common data storage includes all or any types of files for download and synchronization: Audio (music files), Video (movie files), Photo (picture files), text (SMS-, Twitter files), Books/news (Text and picture files).

In a fourth embodiment the one or more users being identified by an ID obtained via one of the standard means: a camera and face detection, a camera and eye iris detection, fingerprint detection, or touch on a predefined button.

In the following, embodiments of the invention will be described with reference to the drawing, wherein:

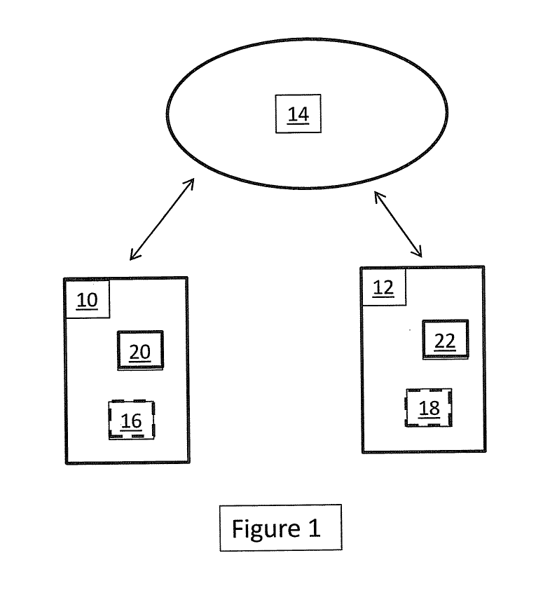

FIG. 1 is an overall overview of an embodiment of the invention and

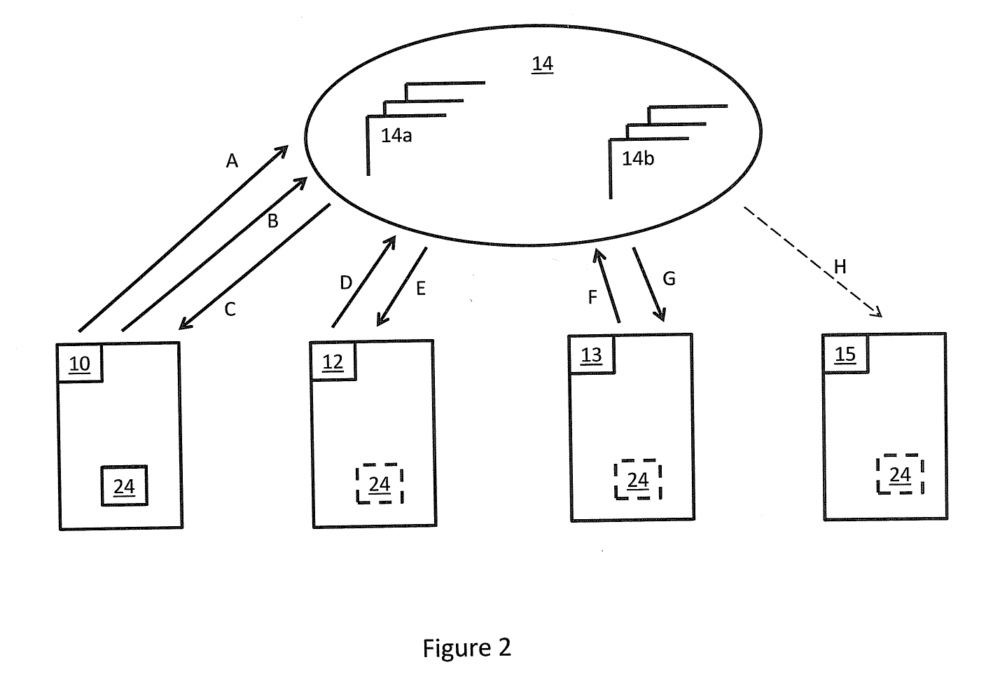

FIG. 2 illustrates another embodiment.

### TERMS USED

A media player processes and provides information: the media player performs a play back of a media file as addressed in the data set; e.g. an MP3 file is accessed and played by the media player.
A data set is a collection of data that represents data for a multimedia file, optionally including meta data; this data being e.g. media type, composer, artist, genre, recording date etc. One specific file is reached via an index to that file.
A data set may contain different file types: audio (music), video (movie), photo (pictures), text (e.g. SMS, Twitter), and books (text and picture files).
A collection of data records constitutes a data set. A data record may be one file, e.g. a music MP3 file, a graphical file (a Tiff file) and alike. The collection of data sets (more files) may also be name a “folder”.
A common data storage represents all the data sets.
Control data is a general term for an event supported by a standard two way communication protocols: “a request from one unit to another unit” and “a corresponding response to one unit from another unit”.

In FIG. 1, two devices 10 and 12 communicate via a cloud 14, such as one or more servers or any type of connection, wired or wireless or a combination thereof.

The devices 10/12 may be mobile phones, such as iPhones, tablets, such as iPads, PCs, computers, portables, lap tops, servers, multimedia providers, readers, multimedia players, or the like.

Each device has a user interface, such as a touch pad or touch screen 20/22 as well as a chipset 16/18 of a processor, communication elements, and memory, provided as a single or multiple chips, ASICS, FPGAs or the like, software programmable, hardwired or a combination thereof.

The communication may be performed using any desired protocol, such as the Ethernet protocol, and may be performed wirelessly or wired.

The devices 10/12 are adapted to synchronize data with each other via the cloud 14 or additionally with one or more storage areas, such as in servers, of the cloud 14.

The devices 10/12 may download or otherwise receive data, such as multimedia files, from the cloud 14, such as from the other of the devices 10/12, from other sources (where the chipset 16/18 comprises other communication means, such as for wired or wireless Ethernet, Bluetooth, IR and/or RF communication or the like) or from an internal media provider, such as a camera, which may also form part of the chipset 16/18.

In the memory of the chipset 16/18, a number of media storage areas are defined which each may hold or store a number of media files. Each area and/or each file being reserved for one or more of a group of users or potential users.

A media file may represent audio, video, text, images, pictures, or the like—of any kind, such as music, pod casts, radio shows, TV shows, books, articles, pod casts, movies, films, clips, images, fotos, or the like.

When a media file is stored in the device 10/12, the user storing the file is indicated, and the file is stored in an area reserved for that user, or reserved for at least that user, and/or the file is provided with additional data indicating the user or one or more of the users.

Then, each of the devices 10 and 12 may hold or store media files for or from a number of different users. When the device 10 wishes to synchronize the contents thereof, or at least the media files, the media files are synchronized either to the cloud 14, from which the media files are synchronized to other devices, such as the device 12. Alternatively, the media files are synchronized directly from the device 10 to the device 12, via the cloud 14 but with no intermediate storage.

Files stored in the cloud 14 thus are also stored in areas reserved for individual users or groups of uses, or the files may be provided with—or retain—data identifying the user or group of users.

In this synchronization, the device 12 is able to inform the cloud 14 or the device 10 of which users are users of or potential users of the device 12, so that the synchronization of data to the device 12 is only performed with data for users or potential users of the device 12.

Clearly, the user(s) of the devices 10 and 12 may be different, even though an overlap is required to synchronize data there between. In one situation, the device 10 is a tablet PC used by multiple members of a family, and the device 12 is a cell phone used solely by one member of the family. In this situation, the media data stored in the tablet 10 for this particular member will be synchronized to the cell phone 12, and the media data from the cell phone 12 will be synchronized to the tablet 10 in a manner so that it is accessible by that member of the family.

When storing a media file on the device 10 or 12, and when multiple users are able to access the device 10/12, the user is prompted for an identity, where after the media file is stored in an area reserved for the identified user or a group of users comprising the identified user, or data may be provided in the file identifying the user or group of users.

When using the device 10/12, the present user may access the media library of the device 10/12. The available media library now is that of the area reserved for this user and/or groups of users comprising the user and/or files comprising data identifying the user or group of users. Thus, different users may have different media libraries, whereby even “single user” devices, such as cell phones, iPads or the like, which are not constructed to support use by multiple users, will be able to be personalized in the manner that the media library thereof is personalized. Then, even though multiple users use the device, the media library is not mixed, and it is possible for a user to avoid experiencing other users music, videos, fotos or the like while keeping his/her own files private.

It is noted that other functionalities, such as browsers, may remain general or user-non-specific, so that the general single-user interface may be retained, apart from the situation where the media library is accessed.

FIG. 2 illustrates an embodiment with a cloud 14 having a service provider archive 14a and user data sets of folders and files 14b. The arrows relate to:

A: upload of files,

B, D and F: synchronization instructions

C, E and G: data transfer

H: no synchronization instruction

A “cloud” is defined to be a number of utilities available for user access via the Internet. The utilities may include, but is not limited to, one or more download services and one or more accessible data sets for storage of user data.
As an example, a download service may be a music service from which a user may download/buy music album(s) or individual music tracks, both in terms of music files (e.g. MP3 files).
The download service may be offering any kind of data including multimedia files, e-mail information, MMS data, Twitter data, books, pictures and alike.
As an example, the common data storage is a collection of folder(s) for the one or more users. Files/data that have been downloaded from a service on user request may be stored (uploaded) onto the data set on the server. The files are organized in a standard folder hierarchy for each of the individual user(s).
The cloud is accessed from the portable devices via standard Internet access means, like routers, being wired or wirelessly according to an actual system setup.

The synchronization of data among the portable devices is based on the complete data set organized in the one or more user folders and the predefined constraints for the mode of synchronization among the users.

The user data sets may be organized per user in a traditional hierarchy of folders and subfolders, e.g., but not limited to:

User: [device x folder], [device y folder], . . . [device n folder]; this relate the users to the device folders.

Device: [user 1, user 2 . . . ]; this relate the devices 10, 12, 13 and 15 to the users.

Device: [photo subfolder & files], [music subfolder & files], [video subfolder & files], [etc. . . . ]; this relates the devices to the data files in the miscellaneous folders.

Constraints Tables—Available Synchronize Options

| (Example) | To User 1 | To User 2 | To User n |
|---|---|---|---|
| Data from | All devices | All devices | All devices |
| User 1 | | | |
| All data | Device x | Device x | Device x |
| | (mmplayer) | (mmplayer) | (mmplayer) |
| Photo | Device y (phone) | Device y (phone) | Device y (phone) |
| Music | Device z (tablet) | Device z (tablet) | Device z (tablet) |
| Video | | | |
| etc. | | | |
| Data from | All devices | All devices | All devices |
| User 2 | | | |
| All data | Device x | Device x | Device x |
| | (mmplayer) | (mmplayer) | (mmplayer) |
| Photo | Device y (phone) | Device y (phone) | Device y (phone) |
| Music | Device z (tablet) | Device z (tablet) | Device z (tablet) |
| Video | | | |
| etc. | | | |
| Data from | All devices | All devices | All devices |
| User n | | | |
| All data | Device x | Device x | Device x |
| | (mmplayer) | (mmplayer) | (mmplayer) |
| Photo | Device y (phone) | Device y (phone) | Device y (phone) |
| Music | Device z (tablet) | Device z (tablet) | Device z (tablet) |
| Video | | | |
| etc. | | | |

An example is displayed with two users and with different options per device.

Examples of the devices are a multimedia player “mmplayer” (e.g. iPod Touch), a mobile phone (e.g. iPhone) and a tablet PC (e.g. iPad).

Optional selections are indicated with a bolded “*”.

| | To User 1 | To User 2 |
|---|---|---|
| Data from User 1 | *All devices | All devices |
| *All data | Device x (mmplayer) | Device x (mmplayer) |
| Photo | Device y (phone) | Device y (phone) |
| Music | Device z (tablet) | *Device z (tablet) |
| Video | | |
| etc. | | |
| Data from User 1 | *All devices | All devices |
| All data | Device x (mmplayer) | *Device x |
| | | (mmplayer) |
| Photo | Device y (phone) | Device y (phone) |
| *Music | Device z (tablet) | Device z (tablet) |
| Video | | |
| etc. | | |
| Data from User 2 | All devices | All devices |
| All data | Device x (mmplayer) | *Device x |
| | | (mmplayer) |
| *Photo | Device y (phone) | *Device y (phone) |
| Music | *Device z (tablet) | *Device z (tablet) |
| Video | | |
| etc. | | |

Any type of data residing on one portable device may be synchronized to other portables via the server in the “cloud”. Examples of data files to synchronize include, but not limited to: photo, music, video, text, books, SMS, e-mail, twitter and alike.

Furthermore application programs (apps) downloaded to one portable may be distributed to other portables, if this is allowed according to licensing terms for the application in question.

This includes also data for e.g. calendar, address book, phone book, e-mail addresses and Skype addresses and alike.

The required structure of the user dataset residing on the server, i.e. the hierarchy of folders and subfolders and file contents are adapted to accommodate to the functional requirements of the synchronization feature.

With reference to FIG. 2 operational scenarios are disclosed:
1. The first user takes a photo by means of the first device 10; this action generates a picture file (e.g. a Tiff file) on the first device. Thus a data record is amended to the storage in the device.
2. The first user buys a music album from a music store 14a; this action generates a download of the corresponding file (e.g. an MP3 file) from the service provider to the first device. Thus a data record is amended to the storage in the first device.
3. The user commands e.g. via a specific key on the user interface on the first device a synchronization to take place with other portable devices. The synchronization will now take place according to the constraints defined for the individual portable devices.
4. In this example the constraints might be defined to allow that picture files and music files are synchronized to all devices 12, 13, 15 for the specific first user and to the device that is shared with a second user.
5. Accordingly the picture file and music file are uploaded to the user data sets in the common data storage 14b and further distributed to the devices 12, 13 that are part of the synchronization, i.e. the second device 12 and the third device 13, but not the fourth device 15,
6. In an alternative flow of operation, the photo taken by the first user is synchronized to the device of the second user applying the fourth device. Thus, instead of the NO SYNC indication of the fourth device, this shall be is marked with a second synchronize event, thus the fourth device will be updated.

The invention is very applicable to establish a system enabling a number of portable devices, shared among two or more people to be synchronized with the same data sets and files as, on each of the devices and according to predefined user demands.

The synchronization of the devices to run automatically via a common data server attached to the Internet.

### EMBODIMENTS

1. A method to synchronize one or more portable devices, frequently used by two or more people, with data from a common data storage, the synchronization characterized by:
a. An action triggered by a first user operation performed on first device generates a first data record in the first device, the data record partly or fully being the output from an application program running in the first device or the data record partly or fully being data downloaded from a service provider on a networked server (cloud);
b. Upon a first synchronization event, the first data record is uploaded from the first device to the server (cloud) and appended to the server data sets that include user data from one or more users;
c. Upon a second synchronization event, the first data record is downloaded from the server (cloud) and appended to the data sets residing on each of the addressed devices;
d. The addressed devices are according to specified synchronization options, the options being to synchronize all devices, or synchronize all devices for specific one or more user(s), or synchronize specific devices for specific one or more user(s).
2. A method according to embodiment 1, where the first synchronization event being one of:
   a. Executes automatically per time unit, like a system function running in the device;
   b. Executes per user request, like a user given command;
   c. Executes per server (cloud) request like a system function running in the server.
3. A method according to embodiment 1, where the second synchronization event being one of:
   a. Executes automatically per time unit, like a system function running in the device;
   b. Executes per user request, like a user given command;
   c. Executes per server (cloud) request like a system function running in the server.
4. A method according to embodiment 2-3, where the common data storage includes all or any types of files for download and synchronization: Audio, Video, Photo, text, Books/news.
5. A method according to embodiment 4, where the one or more users being identified by an ID obtained via one of the standard means: a camera and face detection, a camera and eye iris detection, fingerprint detection, or touch on a predefined button.

1. A method of synchronizing a first and a second device, the method comprising:
a) receiving or generating a media file in or at the first device,
b) receiving, after step a), an indication of a user identity of a user and storing the media file in the first device in accordance with the indicated user identity,
c) synchronizing the stored media file to the second device,
wherein the synchronizing step comprises:
transmitting the media file and first information relating to the user identity to a synchronizing unit,
the second device holding second information relating to the identity/ies of one or more users to the synchronizing unit,
the second device receiving the media file from the synchronizing unit, and storing the media file, if the user identity of the first information matches a user identity of the second information.

2. The method of claim 1, wherein the synchronization step comprises the second device transmitting to the synchronizing unit the second information and the synchronizing unit transmitting the media file to the second unit, if the user identity of the first information matches a user identity of the second information.

3. The method of claim 1, wherein the synchronization step comprises the synchronizing unit transmitting the media file and the first information to the second unit, and the second unit storing the media file if the user identity of the first information matches a user identity of the second information.

4. The method according to claim 1, wherein the step of the second device storing the media file comprises the second device storing the media file in accordance with the indicated identity.

5. The method according to claim 1, further comprising the step of, subsequently to step b), receiving a second indication of a user identity and providing access to media files stored in accordance with the identity of the second indication.

6. A system comprising a first and a second device as well as a synchronizing unit, wherein:
the first device comprises:
a media file receiving part and/or a media file generating element,
an input element operable to receive an indication of a user identity of a user,
a first storage,
a first processor operable to operate the input element subsequent to the media file receiving part and/or the media file generating element and to store a received or generated media file in the first storage in accordance with the indicated user identity, and
an output element operable to output a stored media file and first information relating to the pertaining indicated user identity,
the synchronizing unit comprises:
a first receiver for receiving the stored media file and the first information,
a second receiver for receiving second information relating to the identity/ies of one or more users,
an output for outputting the media file and the first information to the second device,
and a processor operable to compare the first and second information and instruct the output to output the media file when the first information matches the second information,
the second device comprises:
a second receiver for receiving the media file,
a second output for outputting the second information,
a second storage and
a second processor operable to store the media file in the second storage.

7. A system comprising a first and a second device as well as a synchronizing unit, wherein:
the first device comprises:
a media file receiving part and/or a media file generating element,
an input element operable to receive an indication of a user identity of a user,
a first storage,
a first processor operable to operate the input element subsequent to the media file receiving part and/or the media file generating element and to store a received or generated media file in the first storage in accordance with the indicated user identity, and
an output element operable to output a stored media file and first information relating to the pertaining user identity,
the synchronizing unit comprises a first receiver for receiving the media file and the first information and an output for outputting the media file and the first information,
the second device comprises:
a second receiver for receiving the media file and the first information,
a second storage and
a second processor operable to compare the first information to second information relating to the identity/ies of one or more users of the second device and to, if the first information matches the second information, store the media file in the second storage.

8. A system according to claim 6 wherein the second processor is operable to store the media file in accordance with the first information.

9. The system according to claim 6, wherein the first input element is further operable to receive a subsequent, second indication of a user identity, where the processor is operable to receive the second indication and provide access to media files stored in accordance with the identity of the second indication.
